(19) United States
(12) Patent Application Publication
(10) Pub. No.: US 2014/0366774 A1
(43) Pub. Date: Dec. 18, 2014

(54) ADDITIVES FOR INDUSTRIAL BITUMEN

(71) Applicant: CECA S.A., LA GARENNE COLOMBES (FR)

(72) Inventors: GILLES BARRETO, MESSIMY (FR); JUAN ANTONIO GONZALEZ LEON, LYON (FR)

(73) Assignee: CECA S.A., LA GARENNE COLOMBES (FR)

(21) Appl. No.: 14/301,879

(22) Filed: Jun. 11, 2014

Related U.S. Application Data
(60) Provisional application No. 61/834,563, filed on Jun. 13, 2013.

(30) Foreign Application Priority Data
Jun. 13, 2013 (FR) 13.55470

(51) Int. Cl. C08K 5/3445

(52) U.S. Cl. CPC C08K 5/3445
USPC 106/284.4

(57) ABSTRACT

The present invention relates to industrial bitumen compositions comprising at least one industrial bitumen, and at least one surface-active agent for reducing the viscosity of said bitumen. The present invention also relates to the use of said industrial bitumen compositions for the preparation of industrial bitumen-containing products, as well as the products thus obtained.

This application claims the benefit of priority from Provisional Application Ser. No. 61/834,563, ADDITIVES FOR INDUSTRIAL BITUMEN, filed Jun. 13, 2013, and French Patent Application No. 13.55470, filed Jun. 13, 2013, the disclosures of which are incorporated herein by reference.

### FIELD OF THE INVENTION

The present invention pertains to the field of industrial bitumens, particularly to the use of specific surfactants for reducing the viscosity of such industrial bitumens, and more particularly of bitumens useful for the manufacture of impervious products. The present invention also relates to industrial bitumen compositions comprising at least one of said specific surface-active agents.

### BACKGROUND OF THE INVENTION

Impervious products include all types of products that are fully or at least partially sealant to liquids and/or gases and/or temperature and/or noise. As non limitative examples, impervious products in the sense of the present invention typically include roofing products, waterproofing products, sound dampening products, thermal dampening products, adhesives, under carriage sealants for the automobile industry, electric cable joints protections, joint filling compounds, bituminous marine mastics used for example for oil and gas pipeline joints, and the like.

Such impervious products generally contain at least one industrial bitumen, as well as, in order to improve their rheological properties, various mineral and/or organic dispersed elements such as particles, beads, flakes, aggregates, fibers, and the like.

Among impervious products, roofing products are commonly and mostly sorted into three main types, which are: build-up roofings, bituminous membranes (mainly used for flat or low slope roofs) and shingles (mainly used for steep slope roofs). Membranes are mostly marketed in Europe, while shingles and build-up roofings are mostly marketed in North America.

Membranes and shingles are generally prepared from a non-woven support (fabric, polymer mat, organic or inorganic felt, and the like) which is then saturated with one or more bituminous compositions commonly comprising at least one industrial bitumen, typically an oxidized bitumen. Additional layers of the same or other bitumen(s) or bituminous composition(s) may then be applied to the saturated support. These layers may comprise hard bitumen, oxidized bitumen, polymer modified bitumen and a bitumen containing various mineral and/or organic dispersed elements. Reference articles to these roofing products and manufacture processes thereof are, for example and in a non limitative way “Asphalt fume exposures during the manufacture of asphalt roofing products” (Publication no. 2001-127 by NIOSH (US), (2001), available from www.cdc.gov/niosh), and “The Bitumen Roofing Industry—A global Perspective” published by the Asphalt Roofing Manufactures Association, 2^{nd} edition, March 2011, also available on the internet.

Bitumens or asphalt binders used for the above mentioned uses, sometimes called “roofing bitumens” for roofing products, include different kinds of bitumens. Most commonly used are bitumens that have undergone at least one chemical modification, such as oxidation, in order to increase their mechanical properties such as ring and ball temperatures and also viscosity. Increasing mechanical properties of bitumens used for the preparation of impervious products is necessary to avoid flowing or any degradation (flowing, braking, melting, etc.) during use caused by weather conditions (rains, sun heat, and the like), fumes, oils, solvents and vapors thereof.

As a major drawback, during preparation of said impervious products such bitumens with high ring and ball temperature and/or viscosity need be heated at elevated temperatures, generally about 180° C. to 200° C. or more, in order to reach a bitumen viscosity level compatible with the manufacture process and desired production speed.

Such high temperatures, which are necessary to efficiently work these hard bitumens during impregnation of the support of shingles or membranes, involve a high energy consumption, and generate fumes that may be hazardous for the workers and for the environment. It should be noted that bituminous products, which are processed at temperatures above 200° C. are outside REACH registration compliances.

U.S. Pat. No. 6,306,937 clearly raises the issues of high viscosity bitumens used for roofing products, and discloses known techniques for reducing viscosity of hard bitumens, whether oxidized or not, said techniques making use of important amounts of solvents, such as mineral spirit solvents, and proposes to add polybutene in order to decrease the viscosity of bitumens at low temperatures. Other components may be added such as known hydrophobic agents, as well as fatty acids and amines to facilitate the incorporation of polybutene into the bitumen. However adding polybutene as well as hydrophilic agents is said to increase the viscosity at high temperatures and huge amounts of mineral spirit solvents are required to decrease the viscosity to acceptable levels in the examples.

Patent CA1260653 discloses modified asphalts compositions for use as roofing materials, said compositions having a low viscosity at elevated processing temperatures while retaining their mechanical properties at usage temperatures. Addition of from 2% to 10% of a bis-stearoylamide is said to be useful in reducing the viscosity of a bituminous composition for roofing application at processing temperatures. The practical reduction in viscosity shown in the examples is achieved by replacing a full blown bitumen (high viscosity) with a mixture of full blown and partially oxidized bitumen (of lower viscosity) in the presence of the bis-stearoylamide additive. This additive is therefore not used to decrease the viscosity but to compensate the reduction in ring and ball temperature observed with the use of a partially oxidized bitumen.

Patent application JP10182981A discloses a composition that can prevent a water-proof asphalt layer, useful as an asphalt roofing material, from being deteriorated by alkaline water. This composition contains an acid organophosphate with a P—OH radical comprising a long-chain hydrocarbon intramolecular group in a ratio of 0.1 wt % to 5 wt % relative to the asphalt composition. The composition also contains an inorganic phosphorus compound, for example chosen from phosphorus pentaoxide (P₂O₅), polyphosphoric acid, phosphorus pentasulfide (P₂S₅), oxyphosphorus trichloride (POCl₃) and phosphorus trichloride (PCl₃₃), in a ratio of 0.075 wt % to 5 wt % relative to the asphalt composition According to this disclosure, a fiber sheet saturated with an asphalt composition containing a blend of an acid organophosphate and an inorganic phosphorus compound, leads to an asphalt system roofing material for which degradation by alkaline moisture can be prevented. However, it is currently known within the asphalt binder industry that inorganic phosphorus compounds actually tend to increase the viscosity of an asphalt binder. Such effects are described for example in FR-A-2065076 and in “Energy and Fuels”, (2008), vol 22, page 2637 by J. F. Masson.

Additives that could decrease the viscosity of hard bitumens, while retaining the mechanical properties at application temperatures, could also be used to decrease the production temperature of the bituminous products (thus improving handling of the products and safety of the process). Such additives could also be used to increase the production rate of the impervious products, while keeping on working at conventional elevated temperatures, since viscosity is an important variable that steers the process speed, for example maximum speed at which the bitumen impregnation into the support takes place.

### SUMMARY OF THE INVENTION

There is still therefore, and this is a first objective of the present invention, a need for industrial bitumen compositions, such as hard bitumen compositions, and particularly oxidized bitumen compositions, which present a moderate to low viscosity at moderate to high temperatures.

As a second objective, the present invention aims at providing industrial bitumen compositions presenting a moderate to low viscosity at moderate to high temperatures, and which can be easily prepared on an industrial scale.

A third objective is to propose industrial bitumen compositions that allow for the quick preparation of efficient impervious materials that could withstand all kinds of degradations (flowing, braking, melting, etc.) during use caused by weather conditions (rains, sun heat, snow, cold, temperature variations and the like), fumes, oils, solvents and vapors thereof.

Still a further objective is to propose industrial bitumen compositions allowing for the preparation of impervious materials at reduced temperatures. Another further objective is to propose industrial bitumen compositions and impervious materials containing said bitumen composition having a smaller stress build-up and/or thermal contraction upon the first cooling experienced during the production process of the said impervious materials. Still another objective is to propose industrial and impervious materials containing said bitumen composition that are easier to recycle.

Still a further objective is to provide industrial bitumen compositions that comprise one or more additives of low toxicity and preferably non toxic or harmful for the environment as well as for human beings and animals.

The inventors have now discovered that the above objectives are met in whole or in part with the oxidized bitumen compositions of the present invention which is herein below explained and detailed.

### BRIEF DESCRIPTION OF THE DRAWINGS

FIG. 1 is a graph of the viscosity at 150° C. as a function of shear stress of bituminous compositions.

FIG. 2 is a graph of the viscosity of a bituminous composition at a shear stress of 10 [1/s] as a function of the bituminous composition temperature.

### DETAILED DESCRIPTION OF THE INVENTION

According to a first aspect, the present invention deals with a bituminous composition comprising:

a) at least one industrial bitumen, and

b) at least one surface-active agent.

Industrial bitumens are all kinds of bitumens that are not intended for preparing asphalt mix for road construction. More specifically industrial bitumens are hard bitumens at application temperature such as for example fully or partially oxidized bitumens and more generally bitumens of high ring and ball temperature, that is to say bitumens generally having a ring and ball temperature substantially higher than bitumens useful for road construction. “Hard bitumens” are well known to the skilled in the art and readily available from bitumen factories as described in the NF EN 13305 (September 2009)

According to a preferred embodiment, “industrial bitumen” means a bitumen having a ring-and-ball temperature (hereinafter referred to as “ring and ball temperature”) ranging from 50° C. to 180° C., preferably from 50° C. to 170° C., more preferably from 70° C. to 160° C., even more preferably from 80° C. to 150° C. inclusive. The “ring and ball temperature” is the temperature at which a disc of the measured material is soft enough to allow a steel ball to fall, enveloped in the bituminous binder, a distance of 25±0.4 mm. For this invention, ring and ball temperature is measured according to the standard NF EN 1427 dated June 2007 using an automatic ring and ball apparatus (such as Normalab Analis NBA440 instrument) with glycerol as the bath liquid.

Throughout the present invention, “oxidized bitumen” means any hard bitumen obtained by any chemical and/or physical treatment in such a way that, when compared with an untreated bitumen, contains an increased proportion of asphaltenes, decreased proportion of naphthenes and polar aromatics and the same proportion of saturates, as described in “The Bitumen Roofing Industry—A global Perspective”, published by the Asphalt Roofing Manufactures Association, 2^{nd} edition, March 2011.

The oxidation of bitumen may be carried out through several artificial means, such as direct reaction with air with or without catalysts at high temperatures, preferably from 200° C. to 280° C. inclusive. The oxidation process may nevertheless “naturally” occur through exposition of bitumen or asphalt binder to air at room temperature for a very long time. Bituminous binders present in road pavements after several years of use are thus also considered as oxidized bitumens in the context of the present invention.

Preferably, “oxidized bitumen” for use in the compositions of the present invention include fully or partially air blown bitumens or asphalts that may or may not contain other additives such as polymer modifiers, also known as bitumen-modifying polymers, as hereinafter explained.

Bitumens that can be used to prepare the above-defined “oxidized bitumens” are any kind of bitumens or asphalt binders, and preferably bitumens chosen from the products obtained from oil by direct distillation or from distillation of oil at reduced pressures, the products obtained from the extraction of tar and bituminous sands, the products of oxidation and/or fluxation with carbonated solvents including paraffins and waxes of such bituminous materials, synthetic bitumens (such as described in FR 2 853 647 A1), tars, oil resins or indene-coumarone resins mixed with aromatic and/or paraffinic hydrocarbons, the mixtures of such and the mixtures of such bituminous materials with acids and the like. These bitumens are modified to the above-defined “oxidized bitumens” by any known techniques from the skilled in the art, for example those described in “The Bitumen Roofing Industry—A global Perspective”, ibid.

The composition of the present invention thus comprises at least one industrial bitumen, preferably at least one hard bitumen and particularly at least one oxidized bitumen as defined above and at least one surface-active agent. Surface active agents that may be used are of any kind of known surface-active agents. Preferred surface-active agents are organic compounds comprising at least one hydrophilic moiety and at least one lipophilic moiety.

In the context of the present invention, “hydrophilic moiety” means any moiety of the surface-active agent that is not a lipophilic moiety. “Lipophilic moiety” means any part of the surface-active agent consisting only of carbon atoms and hydrogen atoms, and wherein 3 or more carbon atoms are directly linked together, through single, double and/or triple bonding, and the hydrocarbon chain of 3 carbon atoms or more may be a combination or not of linear, branched and/or cyclic chains.

According to a preferred embodiment, surface-active agents for use in the present invention are those presenting at least one, preferably at least two, more preferably more than two, and still more preferably all, the following characteristics:
1) the surface-active agent comprises at least one lipophilic moiety for each single hydrophilic moiety;
2) the surface-active agent comprises at least one lipophilic moiety which is an aliphatic or unsaturated or aromatic hydrocarbon chain with 6 carbon atoms or more;
3) the surface-active agent is an organic compound comprising at least one heteroatom, preferably at least two heteroatoms, chosen from among oxygen, nitrogen, phosphorous and sulfur;
4) the surface-active agent is an organic compound of molecular weight ranging from 50 Dalton to 2000 Dalton, preferably from 150 Dalton to 1500 Dalton and more preferably from 250 Dalton to 1000 Dalton inclusive;
5) the surface active agent comprises at least one oxygen atom, and the ratio of the total number of oxygen atoms (0) to the total number of carbon atoms (C) is such that 0<O/C≦0.5, preferably 0<O/C≦0.33;
6) the surface active agent comprises at least one oxygen atom and at least one nitrogen atom, and the ratio of the total number of oxygen atoms (O) to the total number of nitrogen atoms (N) is such that 1≦N/O<4, preferably 1≦N/O≦3.

Preferred surface-active agents for use in the present invention are those having characteristics 1), 2) and 3) as defined above. Most preferred surface-active agents for use in the present invention are those having characteristics 1), 2), 3) and 4) as defined above.

According to another preferred embodiment the surface-active agents for use in the present invention are organic compounds comprising at least one chemical group chosen from among C═O, S═O and P═O.

According to another preferred embodiment the surface active agents for use in the present invention comprise only one lipophilic moiety containing at least 4 carbons when more than one amide moiety is present, wherein “amide moiety” means a —C(═O)—N grouping within a linear (i.e. non cyclic chain) chain.

According to another preferred embodiment, the surface-active agent is an organic compound comprising at least two heteroatoms, chosen from among oxygen, nitrogen, phosphorous and sulfur, and any of the other above-listed characteristics.

According to another preferred embodiment the surface active agents for use in the present invention do not contain any —NH₂ group.

According to still another preferred embodiment, the surface-active agent for use in the composition of the present invention is a fatty acid chosen from among, by way of non-limiting examples, C₆-C₃₀, preferably C₈-C₂₆, linear or branched, saturated or partially unsaturated carboxylic acids. Examples of such fatty acids include capronic, caprylic, pelargonic, capric, undecylic, lauric, tridecylic, mystiric, myristoleic, palmitic, palmitoleic, stearic, oleic, ricinoleic, linoleic, arachidic, arachidonic, cerotic, montanic, and melissic acids, and mixtures thereof.

Still according to another embodiment, the surface-active agent for use in the composition of the present invention is a fatty amide chosen from among non-substituted, mono-substituted or di-substituted C₆-C₃₀, preferably C₈-C₂₆, linear or branched, saturated or partially unsaturated alkylamides. Examples of such fatty amides include, in an illustrative and non-limiting way, hexanamide, heptanamide, octanamide, nonamide, decenamide, undecenamide, dodecenamide, 9c-dodecenamide, tridecenamide, tetradecenamide, 9c-tetradecenamide, hexadecenamide, 9c-hexadecenamide, octadecenamide, 6c-ocatdecenamide, 9c-ocatdecenenamide, 12-hydroxy-9c-octadecenamide, 9c,12c,15c-octadecenamide, nonadecenamide, eicosanamide, and mixtures thereof.

As another preferred embodiment, the surface-active agent is chosen from among esters of phosphoric acid, and preferably from (di)alkyl phosphate esters, still more preferably alkoxylated (di)alkyl phosphate esters, such as ethoxylated, propoxylated and/or butoxylated (di)alkyl phosphate esters, such as for example those described in WO 2008/148974. Examples of alkoxylated alkyl phosphate esters are ethoxylated alkyl phosphate esters and mixtures thereof, a typical example being Cecabase® RT BIO9 available at CECA S.A.

According to a further preferred embodiment, the surface-active agent for use in the present invention comprises at least one, and preferably one, five- or six-membered nitrogen-containing heterocyclic ring, and optionally but preferably an amide group. Examples of such surface-active agents include C₆-C₃₀, preferably C₈⁻C₂₆, linear or branched alkylamido alkylene imidazolidinone, for example N-[2-(2-oxo-1-imidazolidinyl)-ethyl]-9-octadecenamide (CAS 87041-09-6), C₆-C₃₀, preferably C₈-C₂₆, linear or branched alkylamido alkylene piperazine, for example Cecabase® 280, available at CECA S.A., and mixtures thereof.

Another embodiment of the present invention makes use of surface-active agents chosen from among carboxylic acid salts of amines and diamines, such as alkyl diamine di(fatty carboxylate) salts. Examples of such diamine dicarboxylate salts include Inipol® 002 and Inipol® OT2 available at CECA S.A., and mixtures thereof.

Still another embodiment of the present invention makes use of surface-active agents chosen from alkoxylated amines and alkoxylated polyamines, such as ethoxylated and/or propoxylated and/or butoxylated fatty alkylamines and ethoxylated and/or propoxylated and/or butoxylated fatty alkyl-polyamines, for example Dinoramox® S12, Dinoramox® S7 available from CECA S.A., and the like as well as mixtures thereof.

According to another preferred embodiment the surface active agents for use in the present invention do not loose more than 15% of their weight, preferably not more than 10%, more preferably not more than 5%, of their weight at 200° C. when subjected to a standard thermogravimetric analysis under air (1 L/h) with a heating ramp of 2° C./min.

According to another preferred embodiment the surface active agents for use in the present invention decrease by 20%, preferably by 40%, more preferably by 50%, most preferably by 60% the viscosity of an industrial bitumen as measured in an dynamic shear rheometer at 150° C. at a shear stress of 0.1 s-1 using a parallel plate geometry (25 mm diameter) after being subjected to heating for 20 min at the same temperature.

The amount of surface-active agent(s) present in the composition of the present invention may vary in great proportions. However the amount of surface-active agent(s) is indeed lower than would be necessary the amount of a conventional solvent in order to reduce the viscosity of the said bitumen. Hence the amount of surface-active agent(s) present in the composition of the invention is generally ranging from 0.1 wt % to 4 wt % inclusive relative to the total weight of the said composition, preferably from 0.3 wt % to 3 wt % inclusive, and still more preferably from 0.5 wt % to 2 wt % inclusive relative to the total weight of the said composition. A smaller amount of surface-active agent(s) would not lead to an efficient viscosity reduction of the industrial bitumen, and a higher amount would act as a liquid solvent and would adversely affect the mechanical properties of the bitumen at application temperatures.

The composition of the present invention may further comprise other additives known by the skilled in the art, such as for example, and preferably chosen from among polymers, fibers, clays, minerals, fillers, carbon nanotubes, fiberglass, wood pulp, ground rubber, organic anti-strips and the like as well as mixtures thereof. However, inorganic phosphorus-containing additives, and especially those chosen from among phosphorus pentaoxide (P₂O₅), polyphosphoric acid, phosphorus pentasulfide (P₂S₅), oxyphosphorus trichloride (POCl₃) and phosphorus trichloride (PCl₃), are not preferred as further additives. When such inorganic phosphorus-containing additives are present in the composition of the invention, their proportion should not exceed 0.07 wt % relative to the said industrial bitumen composition.

Therefore, and as a preferred embodiment, the present invention relates to a bituminous composition comprising at least one industrial bitumen as defined above, at least one surface-active agent as defined above and optionally at least one inorganic phosphorus additive chosen from among phosphorus pentaoxide (P₂O₅), polyphosphoric acid, phosphoric acid, phosphorus pentasulfide (P₂S₅), oxyphosphorus trichloride (POCl₃) and phosphorus trichloride (PCl₃) in an amount of less than 0.07 wt % relative to the total weight of the bituminous composition.

Polymers that may be present in the compositions of the present invention are any type of polymers, preferably polymer modifiers, also known as bitumen-modifying polymers.

Such polymers, either linear or branched and/or chemically crosslinked, are well known to the skilled artisan and include, as non-limiting examples, polybutadiene, poly-isoprene, polychloroprene and their hydrogenated versions, polyisobutylene, bloc copolymers of polybutadiene and isoprene with styrene, and their hydrogenated versions like poly styrene-b-butadiene (SB), poly styrene-b-butadiene-b-styrene (SBS), poly styrene-b-isoprene-b-styrene (SIS), poly styrene-b-(isoprene-stat-butadiene)-b-styrene or poly styrene-b-isoprene-b-butadiene-b-styrene (SIBS), hydrogenated SBS (SEBS), poly styrene-b-butadiene-b-methyl methacrylate (SBM), its hydrogenated version (SEBM), poly methyl methacrylate-b-butylacrylate-b-methyl methacrylate (MAM), poly styrene-b-butyl acrylate-b-styrene (SAS), statistic copolymers of butadiene with styrene (SBR) and acrylonitrile (NBR) and their hydrogenated versions, butyl rubber or halogenated one, polyethylene, polypropylene, ethylene-vinyl alcohol copolymer, ethylene-vinyl acetate copolymer, ethylene-propylene copolymer and ethylene-propylene-diene copolymer (EPDM), copolymers of ethylene with acrylic monomers, copolymers of ethylene and acrylic esters, copolymers of ethylene, acrylic ester, maleic anhydride, copolymers of ethylene, acrylic ester, functionalised acrylic ester like glycidyl acrylate or methacrylate, available by the ARKEMA company under the brand name LOTADER®, acrylic or methacrylic polymers or copolymers like the resins based on (meth)acrylic esters such as poly butyl acrylate and its copolymers with styrene, methyl methacrylate or other acrylic monomers, as well as their mixtures.

The composition of the present invention may be prepared according to any process known to the skilled in the art. Advantageously, the surface-active agent(s) is(are) added into an industrial bitumen that is previously heated to a temperature ranging from 150° C. to 250° C. Other additives, such as those described here-above may be added preferably at the same time, or else before or after the surface-active agent(s). The addition of the surface-active agent(s) and the optional other additives is run under agitation or simple simultaneous pouring or sequential pouring of the said additives, according to one or more conventional known techniques and for example using a mechanical agitator and/or a pump recirculation.

According to another aspect, the present invention relates to the use of at least one surface-active agent as here-above defined for lowering the viscosity of a bituminous composition comprising at least one industrial bitumen, preferably one hard bitumen, more preferably one oxidized bitumen.

As depicted above industrial, hard or oxidized bitumens are highly viscous at elevated temperatures, i.e. oxidized bitumens are of much higher viscosity than the corresponding non-oxidized bitumen at the same temperature. The inventors have surprisingly discovered that adding at least one surface-active agent into an industrial, preferably hard, more preferably oxidized bitumen allows for a significant decrease of the viscosity of said oxidized bitumen.

The addition of at least one surface-active agent as defined above, in an amount of from 0.1 wt % to 4 wt % inclusive, preferably from 0.3 wt % to 3 wt % inclusive, and more preferably from 0.5 wt % to 2 wt % inclusive, into a bituminous composition comprising at least one industrial bitumen as defined above leads to a decrease of the viscosity of the said bituminous composition as described above.

For the purpose of the present invention, the reduction of viscosity (VR) is the ratio defined by the following formula:

$$VR = \frac{{V}_{SA}}{{V}_{IB}}$$

wherein V_{SA} is the viscosity value of the bituminous composition with industrial bitumen a) and surface-active agent b), and
V_{IB} is the viscosity value of the said industrial bitumen a),
and wherein V_{SA} and V_{IB} are measured in an dynamic shear rheometer at 150° C. and at a shear stress of 0.1 s⁻¹, using a parallel plate geometry (25 mm diameter) after being subjected to heating for 20 min at the same temperature.

The present invention therefore also relates to bituminous compositions comprising at least one industrial bitumen as defined above and at least one surface-active agent which allows for a reduction of viscosity (VR as defined above) such as: 0<VR≦0.8, preferably 0<VR≦5 0.6, more preferably 0<VR≦0.5, most preferably 0<VR≦0.4.

Contrary to the teaching of the prior art (see e.g. WO 2008/148974), where surface-active agents, such as phosphate esters, do not alter the viscosity of conventional bitumens, it is presently shown that surface-active agents do have an effect on the viscosity of oxidized bitumens: as said above the viscosity is substantially lowered.

Decreasing the viscosity of industrial bitumens, without modifying or substantially not modifying their other mechanical properties, has for long been a problem in the industry, and the present invention now solves this problem in a simple and efficient way. Preparation of industrial bitumen-containing products, such as impervious materials, and the like with the compositions of the present invention can now be carried out at lower temperatures, thus avoiding toxic and hazardous fumes, and saving heating energy.

Alternatively preparation of industrial bitumen-containing products and the like with the compositions of the present invention can now be carried out at high temperatures, thus allowing for even lower viscosity, as compared to said bitumens with no surface-active agents, and consequently more rapid and therefore more economic preparation processes.

Thanks to the bituminous compositions of the invention, it is also possible to combine both the above advantages for the production of industrial bitumen-containing products particularly impervious products, i.e. combining the lowering of the production temperature and at the same time the increase of the production rate.

Alternatively preparation of industrial bitumen-containing products, such as impervious materials and the like with the compositions of the present invention can now be carried out at high temperatures, thus allowing for even lower viscosity, as compared to industrial bitumens with no surface-active agents. As an advantageous consequence, smaller stress build-up and/or thermal contraction is(are) observed during production process of industrial bitumen-containing products, and typically during production process of impervious products such as shingles or membranes on cooling. The bituminous composition described in the invention may thus be applied to a substrate to produce an impervious product, wherein the substrate or support may be previously treated with another coating. Non-limiting examples of supports include floors, walls, roofs, ceilings, pipes, and organic or inorganic woven or non-woven flexible supports such as cellulose fibers, fiberglass, or polyester felts. It has been observed, as a further advantage, that the surface-active agent present in the bituminous composition of the invention allows for a better wetting of said substrate or support.

The bituminous compositions of the invention may thus also provide additional advantages to the production and final properties of industrial bitumen-containing products as lower stresses need to be applied, for example to a non-woven support during production of shingles, membranes and the like. In a similar manner, the production at lower temperatures by the use of the bituminous compositions of the invention, results in lower residual thermal stresses on industrial bitumen-containing products, improving their final mechanical properties.

As another advantage of the present invention, the industrial bitumen-containing products, such as impervious materials, prepared from at least one composition according to the present invention, are easy to recycle, or are recycled in an easier way as compared to corresponding industrial bitumen-containing products which include no composition of the present invention, thanks to lower viscosities at the recycling process temperatures.

Hence, and according to a further aspect, the present invention relates to the use of at least one industrial bitumen composition as herein before described for the preparation of industrial bitumen-containing products, such as impervious materials, including, in a non limitative way, roofing-, sealing-, and other waterproofing-products, asphalt shingles, polymer-modified bitumen roofings, roll roofing products, membranes, adhesives, pipe coatings, hydraulic products, paving-grade mixes, canal-, ditch- and pond-linings, dams and bridges protection, hydrophobic paints, electric cable joint protections, oil and gas pipeline joints, joint filling compounds, sound dampening products, reinforcing and underlayment felts, undersealing for Portland cement concrete pavements, and the like.

According to still a further aspect, the present invention relates to an industrial bitumen-containing product, such as an impervious material, as listed above.

The present invention is further illustrated by the following examples which do not aim at limiting the sought scope of protection which is defined in the appended claims.

### EXAMPLE 1

Bituminous compositions were prepared as follows: 100 g of a 100/40 oxidized bitumen with a ring and ball temperature of 114° C. (bitumen A) in a metal container is heated to 180° C. in an oven for 2 hours. Afterwards, the container is taken out of the oven and placed onto a mechanical stirring apparatus provided with a temperature controlled heating plate. Once the temperature is stabilized at 180° C., the additive is introduced while stirring. The mixture is then stirred for 10 additional minutes, the stirring is stopped and samples are poured on a silicon mould. The samples are stored for 24 hours at 18° C. overnight before measuring their viscosity with an Anton Paar MCR301 shear dynamic rheometer. The viscosity of the compositions is measured at 150° C. as a function of shear stress from 10 s⁻¹ to 0.1 s-1 using a parallel plate geometry (25 mm diameter) after being subjected heating for 20 min at the same temperature.

Tested composition are:
Pure bitumen A, i.e. without additive;
Bitumen A+3 wt % Solvent 1, which is the methyl ester of rapeseed oil (commercially available as Solvester);
Bitumen A+1 wt % Surface-active agent 1, which is N-[2-(2-oxo-1-imidazolidinyl)ethyl]-9-octadecenamide (CAS 87041-09-6); and
Bitumen A+3 wt % Surface-active agent 1.

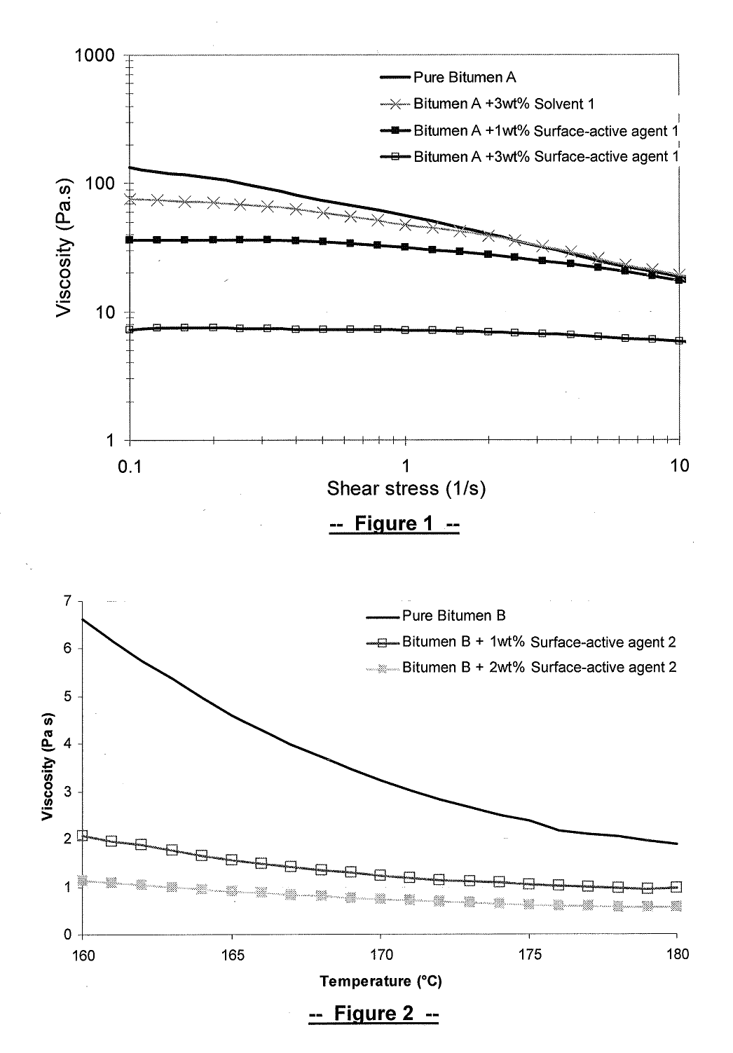

Annexed FIG. 1 shows the viscosity at 150° C. as a function of shear stress of each of the bituminous composition comprising Bitumen A with the indicated amounts of Solvent 1 and Surface-active agent 1.

It is made clear form this FIG. 1 that there is an influence of the shear stress on the viscosity of the pure bitumen A, having a larger value at lower shear stress. The composition containing 3 wt % of solvent has a similar behavior as that of the pure bitumen A with a somewhat lower viscosity at the lower shear stresses. The compositions containing Surface-active agent 1 according to the present invention, show a significant decrease on the viscosity of Bitumen A.

With 1 wt % of Surface-active agent 1, the decrease of viscosity is much larger than that obtained with 3 wt % of Solvent 1. The composition having 3 wt % of Surface-active agent 1 (same amount as for the composition with Solvent 1), shows an even more greater decrease of viscosity, being of more than an order of magnitude lower than the pure bitumen at lower shear stresses. Noteworthy is also the shape of the curve which is different for composition with 3 wt % of Surface-active agent 1, corresponding to a less sensitivity to shear stress.

This example clearly shows that the current invention is not based on dissolution or fluxing, as is the case of a simple solvent, but that there is indeed a surprising effect linked to the addition of a surface-active agent, which actually seems to interact with the oxidized bitumen, resulting in a valuable decrease of its viscosity.

### EXAMPLE 2

Bituminous compositions comprising a blown bitumen R100-40 provided by Shell (Bitumen B) are prepared by adding 1 wt % and 2 wt % respectively of Surface-active agent 2 available as Cecabase® RT B109 available at CECA S.A. One and two grams respectively of Surface-active agent 2 are added to 100 g of Bitumen B, heated to 180° C. and stirred using a mechanical agitator in a similar way as described in Example 1.

The annexed FIG. 2 shows the viscosity of the composition comprising Bitumen B with the indicated amounts of Surface-active agent 2, at a shear stress of 10 [1/s] as a function of the bituminous composition temperature, measured with an Anton Paar MCR301 shear dynamic rheometer using a parallel plate geometry (25 mm diameter).

It can be observed that pure Bitumen B viscosity is quite sensitive to temperature, pretty much folding its value by 3 with only 20° C. difference. On the contrary, compositions according to the present invention, i.e. containing a surface-active agent, respectively at 1 wt % and 2 wt %, show not only a significant lower viscosity at all tested temperatures, but also a much less influence of the temperature on viscosity. This illustrative example of the invention is a clear showing that a preparation process of an oxidized bitumen-containing product may be carried out a temperatures reduced by about 20° C. or more since viscosity is much lower at these lower temperatures than that of pure oxidized bitumen. It is also possible to run such preparation process at higher temperatures, where the viscosity of the compositions of the present invention is still lower than that of pure oxidized bitumen, the advantage of such lower viscosities being easier and faster flowability, mixing, coating, and the like.

### EXAMPLE 3

Nine bituminous compositions (Composition 1 to Composition 9) comprising a blown bitumen R100-40 provided by Shell (Bitumen B) were prepared in a similar way as in Example 2, in order to assess the effect of the addition of a surface-active agent on the viscosity of an industrial bitumen. Samples of these compositions are stored for 24 hours at 18° C. before measuring their viscosity with a Anton Paar MCR301 shear dynamic rheometer. The viscosity of the pure bitumen and of each of the compositions is measured at 150° C. at a shear stress of 0.1 s⁻¹ using a parallel plate geometry (25 mm diameter) after being subjected to heating for 20 min at the same temperature.

Compositions 1 to 6 are the following:
Composition 1 (according to the invention): 1 wt % of Surface-active agent 1, as in Example 1;
Composition 2 (according to the invention): 1 wt % of Surface-active agent 2, which is Cecabase® RT BIO9 available at CECA S.A.;
Composition 3 (according to the invention): 1 wt % of Surface-active agent 3, which is Surfaline® TS18L from CECA S.A. (ethoxylated tristyrylphenol);
Composition 4 (according to the invention): 1 wt % of Surface-active agent 4, which is Dinoramox® S12 from CECA S.A. (ethoxylated alkylamine);
Composition 5 (according to the invention): 2 wt % of Surface-active agent 5, which is Inipol® OO2 from CECA S.A. (diamine dioleate);
Composition 6 (according to the invention): 2 wt % of Surface-active agent 6, which is an octadecanamide (technical grade) from Sigma-Aldrich.
Composition 7 (comparative): 1 wt % of Surface-active agent 7, which is a polyethylene oxide/polypropylene oxide block copolymer surfactant prepared by ethoxylation (18 ethylene oxide units) of a monobutyl ether polypropylene glycol of total molar mass of 3218 g/mol, and has an O/C ratio of 0.364;
Composition 8 (comparative): 1 wt % of Surface-active agent 5, is the oleic acid amide of tetraethylene pentamine (No. CAS 68953-36-6). This surface-active agent has a N/O ratio of 5.
Composition 9 (comparative): 1 wt % of Surface-active agent 2, and 0.4 wt % of phosphorous penta oxide.

The following Table 1 presents the viscosity ratio VR, measured for each of the Compositions 1 to 9.

TABLE 1

| Tested composition | VR |
|---|---|
| Composition 1 | 0.27 |
| Composition 2 | 0.51 |
| Composition 3 | 0.75 |
| Composition 4 | 0.64 |
| Composition 5 | 0.41 |
| Composition 6 | 0.23 |
| Composition 7 | 1.43 |
| Composition 8 | 0.91 |
| Composition 9 | 6.06 |

These results show that Compositions 1 to 6 according to the invention indeed lower the viscosity of an oxidized bitumen, evidencing that as from 1 wt % of a surface-active agent according to the invention, the viscosity of an industrial bitumen is surprisingly and drastically lowered.

These results also show that surface-active agents which are outside the scope of the present invention are either less effective or result in an increase in viscosity at the same concentrations. Particularly, composition 9 presents a high viscosity, more than 6 fold higher than the viscosity of the pure bitumen. This result proves the dramatic effect on viscosity when inorganic phosphorous compounds are present in industrial bitumen compositions.

1. Bituminous composition comprising:
a) at least one industrial bitumen, and
b) at least one surface-active agent.

2. Bituminous composition according to claim 1, wherein the at least one surface-active agent presents at least one of the following characteristics:
1) the surface-active agent comprises at least one lipophilic moiety for each single hydrophilic moiety;
2) the surface-active agent comprises at least one lipophilic moiety which is an aliphatic or unsaturated or aromatic hydrocarbon chain with 6 carbon atoms or more;
3) the surface-active agent is an organic compound comprising at least one heteroatom chosen from among oxygen, nitrogen, phosphorous and sulfur;
4) the surface-active agent is an organic compound of molecular weight ranging from 50 Dalton to 2000 Dalton, inclusive;
5) the surface active agent comprises at least one oxygen atom, and the ratio of the total number of oxygen atoms (O) to the total number of carbon atoms (C) is such that 0<O/C≦0.5;
6) the surface active agent comprises at least one oxygen atom and at least one nitrogen atom, and the ratio of the total number of oxygen atoms (O) to the total number of nitrogen atoms (N) is such that 1≦N/O<4.

3. Bituminous composition according to claim 1, wherein the at least one surface-active agent presents the following characteristics:
1) the surface-active agent comprises at least one lipophilic moiety for each single hydrophilic moiety;
2) the surface-active agent comprises at least one lipophilic moiety which is an aliphatic or unsaturated or aromatic hydrocarbon chain with 6 carbon atoms or more;
3) the surface-active agent is an organic compound comprising at least one heteroatom chosen from among oxygen, nitrogen, phosphorous and sulfur;
4) the surface-active agent is an organic compound of molecular weight ranging from 50 Dalton to 2000 Dalton;
5) the surface active agent comprises at least one oxygen atom, and the ratio of the total number of oxygen atoms (O) to the total number of carbon atoms (C) is such that 0<O/C≦0.5; and
6) the surface active agent comprises at least one oxygen atom and at least one nitrogen atom, and the ratio of the total number of oxygen atoms (O) to the total number of nitrogen atoms (N) is such that 1≦N/O<4.

4. Bituminous composition according to claim 1, wherein the amount of surface-active agent(s) ranges from 0.1 wt % to 4 wt % relative to the total weight of the bituminous composition.

5. Bituminous composition according to claim 1, further comprising at least one other additive chosen from polymers, fibers, clays, minerals, fillers, carbon nanotubes, fiberglass, wood pulp, ground rubber, organic anti-strips, and mixtures thereof.

6. Bituminous composition according to claim 1, further comprising at least one inorganic phosphorus additive chosen from phosphorus pentaoxide (P₂O₅), polyphosphoric acid, phosphoric acid, phosphorus pentasulfide (P₂S₅), oxyphosphorus trichloride (POCl₃) and phosphorus trichloride (PCl₃) in an amount of less than 0.07 wt % relative to the total weight of the bituminous composition.

7. Bituminous composition according to claim 1, wherein the at least one industrial bitumen is a hard bitumen.

8. Bituminous composition according to claim 1, wherein the at least one industrial bitumen is an oxidized bitumen.

9. Bituminous composition according to claim 1, wherein the at least one industrial bitumen has a ring-and-ball temperature ranging from 50° C. to 180° C., inclusive.

10. Bituminous composition according to claim 1, wherein the at least one surface-active agent is a fatty acid chosen from among C₆-C₃₀ linear or branched, saturated or partially unsaturated carboxylic acids.

11. Bituminous composition according to claim 1, wherein the at least one surface-active agent is chosen from capronic acid, caprylic acid, pelargonic acid, capric acid, undecylic acid, lauric acid, tridecylic acid, mystiric acid, myristoleic acid, palmitic acid, palmitoleic acid, stearic acid, oleic acid, ricinoleic acid, linoleic arachidic acid, arachidonic cerotic, montanic, and melissic acids, and mixtures thereof.

12. Bituminous composition according to claim 1, wherein the at least one surface-active agent is a fatty amide chosen from among non-substituted, mono-substituted or di-substituted C₆-C₃₀ linear or branched, saturated or partially unsaturated alkylamides.

13. Bituminous composition according to claim 1, wherein the at least one surface-active agent is chosen from among hexanamide, heptanamide, octanamide, nonamide, decenamide, undecenamide, dodecenamide, 9c-dodecenamide, tridecenamide, tetradecenamide, 9c-tetradecenamide, hexadecenamide, 9c-hexadecenamide, octadecenamide, 6c-ocatdecenamide, 9c-ocatdecenenamide, 12-hydroxy-9c-octadecenamide, 9c,12c,15c-octadecenamide, nonadecenamide, eicosanamide, and mixtures thereof.

14. Bituminous composition according to claim 1, wherein the at least one surface-active agent is chosen from esters of phosphoric acid.

15. Bituminous composition according to claim 1, wherein the at least one surface-active agent is chosen from alkoxylated (di)alkyl phosphate esters.

16. Bituminous composition according to claim 1, wherein the at least one surface-active agent comprises at least one five- or six-membered nitrogen-containing heterocyclic ring, and optionally an amide group, said at least surface-active agent being chosen form C₆-C₃₀ linear or branched alkylamido alkylene imidazolidinone, C₆-C₃₀ linear or branched alkylamido alkylene piperazine, and mixtures thereof.

17. Bituminous composition according to claim 1, wherein the at least one surface-active agent is chosen from carboxylic acid salts of amines and diamines.

18. Bituminous composition according to claim 1, wherein the at least one surface-active agent is chosen from ethoxylated and/or propoxylated and/or butoxylated fatty alkyl-amines and ethoxylated and/or propoxylated and/or butoxylated fatty alkyl-polyamines.

19. A method of lowering the viscosity of a bituminous composition comprising at least one industrial bitumen, comprising adding at least one surface-active agent to the at least one industrial bitumen.

20. An industrial bitumen-containing product comprising a bituminous composition comprising at least one industrial bitumen and at least one surface-active agent.

21. The industrial bitumen-containing product according to claim 20, wherein the industrial bitumen-containing product is an impervious product chosen from roofing-, sealing-, and waterproofing-products, asphalt shingles, polymer-modified bitumen roofings, roll roofing products, membranes, adhesives, pipe coatings, hydraulic products, paving-grade mixes, canal-, ditch- and pond-linings, dams and bridges protection, hydrophobic paints, electric cable joint protections, oil and gas pipeline joints, joint filling compounds, sound dampening products, reinforcing and underlayment felts, and undersealing for Portland cement concrete pavements.
